(19) United States
(12) Patent Application Publication
(10) Pub. No.: US 2020/0315922 A1
(43) Pub. Date: Oct. 8, 2020

(54) TALKING PACIFIER APPARATUS

(71) Applicant: Brett Zarda, West Palm Beach, FL (US)

(72) Inventor: Brett Zarda, West Palm Beach, FL (US)

(21) Appl. No.: 16/843,354

(22) Filed: Apr. 8, 2020

Related U.S. Application Data
(60) Provisional application No. 62/830,942, filed on Apr. 8, 2019.

(51) Int. Cl. A61J 17/00; G06F 3/16

(52) U.S. Cl. CPC A61J 17/1011; G06F 3/16; A61J 17/105; A61J 17/1115

(57) ABSTRACT

A talking pacifier that will serve as an interpreter and an advocate for the vocally challenged, namely infants. The device contains a microprocessor coupled to a speaker for providing short musings that will appear to be delivered by the user of the device. In a preferred embodiment an activation button releases a baby's musings on everything from potty talk to politics.

### PRIORITY CLAIM

In accordance with 37 C.F.R. § 1.76, a claim of priority is included in an Application Data Sheet filed concurrently herewith. Accordingly, the present application claims the priority date of U.S. Provisional Patent Application No. 62/830,942 filed Apr. 8, 2019 entitled “Talking Pacifier Apparatus” the contents of which are incorporated herein by reference.

### FIELD OF THE INVENTION

This invention is directed to the field of baby pacifiers, and in particular, to a novelty talking baby pacifier employing a pacifier strap providing entertainment to both the baby and those within listening distance of the baby.

### BACKGROUND OF THE INVENTION

For generations, baby's babble and drool has been dismissed as an incomprehensible step towards future coherence. In reality, the baby is demonstrating signs of development. At a very early age, the baby can show signs of being sarcastic, insightful and cheeky. For example, the baby may be staring at the fan to let you know it's spinning in the wrong direction. The baby may really know that you did not actually steal his nose. The incessant whining and the overdramatic tantrums are cries for attention. Our failure to understand the baby's language doesn't constitute a lack of ability for then to communicate. However, in place of attempting to communicate with the baby, the guardian of the baby typically relies upon a pacifier to quiet the baby. Beneficial to this entire “scene” would be to know what the baby is thinking.

Traditional pacifiers consist of a nipple portion and a housing. The nipple cones in various shapes and sizes and provides soothing for the child when he or she is sucking. The housing of a pacifier cones in various shapes and sizes. The housing is always connected to the nipple portion. A portion of the housing, called the face plate, is of a geometric shape to ensure the child is unable to inadvertently choke on the pacifier. The housing will sometimes have a ring latch that allows the parent or child to better hold on to the pacifier.

Pacifier straps are a convenient accessory in parenting of the baby. This often-tethered “umbilical-like” strap is connected on one end to a pacifier, while the other end is often attached to the clothing of the child, or potentially another location, high chair, car seat, and so forth. The strap ensures that when the baby removes the pacifier (by accident or on purpose), the pacifier remains in convenient reach of the baby. This minimizes the risk of the pacifier getting dirty as well. While pacifier straps are not a required prerequisite for use with pacifiers, straps quickly become a convenience parents won't live without. For instance, if a baby loses a pacifier in between the seats of a car, tosses the pacifier into a public bathroom stall, or simply drops it on the ground and the family dog runs with it, it is likely such situations will prompt the parent to make the pacifier strap an important accessory.

Various pacifiers and like devices to entertain the baby are known in the prior art. U.S. Patent Registration 4,554,919 discloses a musical pacifier comprising a mouthpiece having a single portion. A casing is secured to the mouthpiece for housing an electronic programmed circuit capable of generating signals to produce a musical tune. A sound generator is associated with the circuit to audibly reproduce the signals. A switch is provided to actuate the electronic programmed circuit.

U.S. Patent Registration 5,662,685 discloses a sound producing pacifier which can play music and be activated to play such music remotely.

U.S. Patent Registration 6,066,161 discloses a baby pacifier apparatus with a remote control locator. The baby pacifier is integrated with a locator device that will illuminate and or sound with a musical tone when activated by a remote transmitter device in order to aid caretakers in locating the pacifier if it is misplaced. The baby pacifier comprises a nipple securely attached to a pacifier flange. In addition, the musical or chime module can be activated by the remote transmitter device for an extended playing period for the child's amusement or comfort.

U.S. Patent Registration 5,772,684 discloses a musical pacifier. The pacifier is a watertight, immersion proof musical pacifier, which includes a mouthpiece including a faceguard having a central opening defining an air passage to an integral sealed housing. A nipple has an interior space. A sealable plug mounts the nipple to the mouthpiece with the interior space in communication with the housing through the air passage. A switch-actuated sound generating circuit, disposed in the housing, controllably reproduces audio signals. A pressure sensitive switch normally closes the air passage. The switch electrically actuates the sound generating circuit in response to pressure generated in the nipple.

U.S. Patent Registration 9,173,819 discloses a music pacifier which includes a pacifier frame and a nipple which locates at one side of the frame and a container on the other side of the frame. Within the container, there is a music IC & power supply, an insulating house, and a vibrating transducer.

U.S. Patent Registration 6,193,742 discloses a pacifier with a motion/sound generator. The pacifier has a bulbous nipple mounted to a body portion. The body portion houses a motion generator that causes vibrations that pass through the nipple to the baby's gums, thereby soothing the gums. The vibrations are generated by an unbalanced weight that is set into movement by a motor or a system of gears. A switch activates the pacifier. In the geared embodiment, the motion generator is actuated by winding the gears. A sound generator can be used to generate a melody in addition to the vibrations.

U.S. Patent Registration 6,135,606 is directed to a hand held toy to hold translucent Lollypops, or other similar sucker candies, producing illumination from the interior of the candy. A blinking light varies in color and position to increase the children's amusement while holding the candy. The device has a battery powered light emitting source controlled by a pushbutton switch. Alternatively, the device can be transformed into a blinking, varying color, spotlighted pacifier, attaching to a pacifier cap. It can also be used as a baby entertaining toy by hanging it in any safe place of the cradle. The toy can be designed in different shapes and colors, as can the candies, which can have a wide variety of flavors, colors and shapes, such as balls, discs, stars, polygons, clown heads, flowers, etc. In addition, as many other similar toys, it can be provided with sound, rotation and vibration motions, etc., by adding the appropriate devices or mechanisms.

U.S. Patent Publication 2017/0020788 discloses a lullaby pacifier having a built-in memory system, Bluetooth device, audio system, and control switch. The pacifier is meant for imparting soothing and comforting feelings to the child once it uses the pacifier via an audio system. The pacifier, once activated, is capable of producing music, stories, poems, and a parent's voice via the audio system. The pacifier increases the learning capabilities of a child through the activation of the auditory stimulus.

What is lacking in the art is a pacifier strap that entertains the child as well as the surrounding adults.

### SUMMARY OF THE INVENTION

Disclosed is a talking binkie/pacifier that will serve as an interpreter and an advocate for the vocally challenged. The device provides a soapbox for babies to speak long before they can stand on that soapbox. With a simple push of the button on the pacifier strap, or the like activator, produced are baby's musings on everything from potty to politics.

In one embodiment a strap is used for securing a pacifier with the strap comprising an elongated tube of flexible material having an inner wall and outer wall with a first end securable to the pacifier and a second end securable to a fixed object. The inner wall forms a chamber between the first and second end. The outer wail forms a continuous side wall between the first and second end. An electrical circuit comprising a microprocessor with a memory chip, a speaker coupled to the microprocessor, and a power source, is positioned within the chamber. Activation of the electrical circuit allows the speaker to play a prerecorded voice, sound or noise stored in the memory chip to entertain those in the area surrounded said baby with short musings for the purpose of entertainment, soothing, education.

In another embodiments pacifier is formed from a nipple constructed and arranged for receipt by a baby with a support base secured to the nipple. An electrical circuit comprising a microprocessor with a memory chip, a speaker coupled to the microprocessor, and a power source is secured to the nipple support base. A means for activation of the electrical circuit allows a prerecorded voice stored in the memory chip to entertain those in the area surrounding the baby with short musings.

An objective of the invention is to provide a universal pacifier connection strap with one end able to attach to a generic pacifier, and the other end able to temporarily secure to a different fixed location; the pacifier connection strap having the capability to transmit sound.

An alternative objective of the invention is to provide a pacifier having a housing and nipple, wherein the housing contains a power source, speaker and electronics to play various pre-recorded noises or voices for entertainment purposes. The noises may be activated through a positive contact with the housing by the baby or an adult, or by specific motions or sounds in the vicinity of the pacifier.

Still another objective of the invention is to provide a universal pacifier connection strap with the capability to transmit sound based on remote activation, such as Bluetooth or Wi-Fi.

Still another objective of the invention is to provide a universal pacifier connection strap with the capability to transact sound based on physical activation such as pushing, pulling, pinching, and/or twisting a portion of the strap or the pacifier.

Yet still another objective of the invention is to provide a universal pacifier connection strap with the capability to transmit a variety of sound clips based on activation through remote or physical activation.

Another objective of the invention is to provide a universal pacifier connection strap with the capability to transmit sound with a replaceable or rechargeable power source in the strap.

Another objective of the invention is to provide a universal pacifier connection strap with the capability to transmit sound for the purpose of entertainment, soothing, and education.

Still another objective of the invention is to provide a universal pacifier connection strap with the capability to transmit different sounds based on the selection of the parent, or randomly through the selection of the baby.

Still another objective of the invention is to provide a universal pacifier with the capability to transmit sound in real tine based on noises or voice commands received by a microphone not housed in the strap.

Still another objective of the invention is to provide a universal pacifier with the capability to record sounds or voices in real time received by a microphone housed in the strap that can be then played back through the speaker.

Yet still another objective of the invention is to provide a universal pacifier connection strap with the capability to transmit sound of prerecorded sounds, voices, and noises.

Still another objective of the invention is to provide an entertainment device by placing a baby in a seemingly first-person perspective in a manner similar to the well known comedy show, “Look Who's Talking”, or commercial adaptation, “Boss Baby or E-Trade Baby”; the content is endless. From generic commentary on diapers to niche variants offering wit on the more topical/seasonal subjects (including holiday, sports teams, etc.), both the baby and the parent, and others within earshot, will be entertained.

Other objectives and advantages of this invention will become apparent from the following description taken in conjunction with any accompanying drawings, within which are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a pictorial of the pacifier and strap; and

FIG. 2 is a pictorial of the electronics.

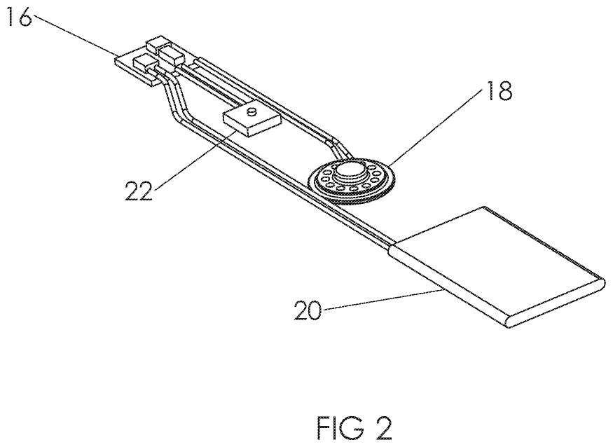

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to employ the present invention to develop any appropriately detailed structure.

The present invention disclosed here is one of a talking pacifier. The pacifier contains a power supply and a speaker. Upon activation, the speaker would emit a series of words or sounds with the intent of entertaining those around the baby. The pacifier might give the impression that the baby is actually talking with short sentences, words, songs, noises, and animal noises (as examples; but not limited to such sounds) that would be entertaining in various languages with various accents. The speaker could be activated through active or passive engagement with the pacifier. This could include a push button on the housing of the pacifier that would activate a speaker when depressed. Alternatively, a portion of the housing, including but not limited to a ring loop, could be pulled to activate. Alternatively, a portion of the pacifier housing could be rotated to activate the speaker. Alternatively, the housing could be pinched or squeezed to be activated. Alternatively, the sucking motion of the child could activate the speaker. The speaker may also be activated wirelessly, via Bluetooth or the like wireless standards.

The speaker could also be activated through various passive means. If the pacifier was removed from the mouth of the baby, the speaker could be activated. A motion sensor could detect movement around the pacifier that could activate the speaker. An accelerometer could detect movement and activate the speaker. Random or interval timing could also activate the speaker.

The pacifier could include a central processing unit with associated memory. In the options defined above, memory would be included in the pacifier with any number of pre-recorded sayings. An access port, i.e. mini or micro USB, or similar future hardware standards, could allow connection to a computer to transfer new data to the memory. Alternatively, a receiver could be contained in the housing, allowing remote transmission of an audio signal (Bluetooth, Wi-Fi, etc.) to activate the speaker. In this scenario, a remote control device could be used to select the specific saying that would be activated. A mobile device, phone or computer could also be used to similarly choose a specific saying for transmission and activation of the speaker.

Alternatively, an additional component attached to the housing could contain the electronics. This could be any form of a plush toy, blanket, animal, or the like component. The electronics may include connection to: Hey Google, Amazon Alexa, and the like systems found in homes and automobiles.

In one configuration, the power supply could be replaced after the battery runs out. The pacifier could be sanitized through various methods without damaging the technology.

In one configuration, the electronics could be semi-permanently attached to the housing of the pacifier. This would allow ‘swapping’ of various modules for a new power supply, different aesthetic designs, or with memory containing various prerecorded noises.

Along with pre-recorded noises, it could be possible to allow owners of the pacifier to record their own sayings. This could be stored locally on memory within the pacifier to subsequently be transmitted to a receiver on the pacifier.

Alternatively, this same concept and various embodiments could be housed in a pacifier strap.

The activation of the speaker could also allow a caretaker to locate a lost pacifier.

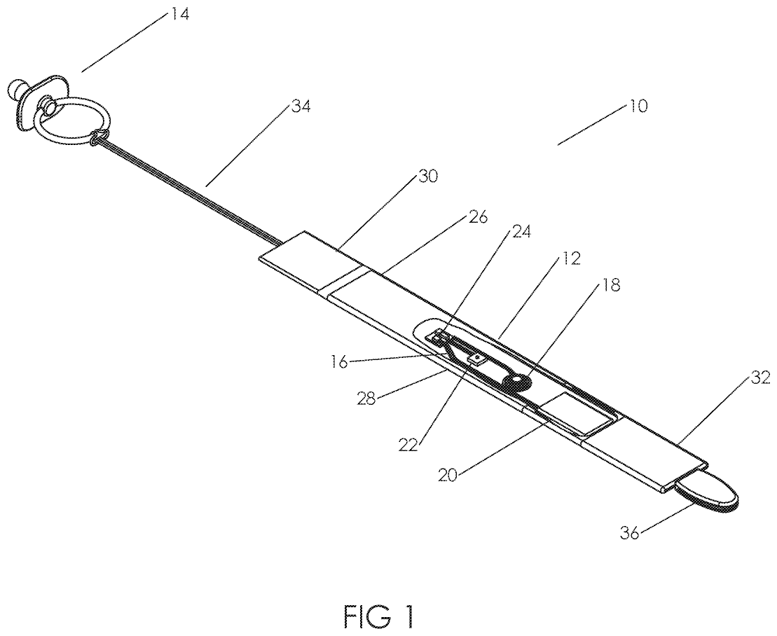

In a preferred embodiment. FIG. 1 depicts the device 10 which looks and feels like a traditional pacifier strap 12 with an attached pacifier 14. Within the strap 12 will be a microprocessor with memory 16, a speaker 18, a power source 20, and a means for activation 22, which, in this embodiment, is a push button. With a push of the button 22 by a parent, a friend, or the unsuspecting baby, the speaker 18 in the strap will allow a prerecorded voice to entertain those within an earshot by playing a short musing about life as a baby. The means for activation can be performed by pushing, pulling twisting or squeezing.

The following are copyright protected musing examples:
Remove this pacifier at your own risk . . . Seriously . . . Step back quietly and think twice.
It's true . . . I am an emotionally unstable pint size dictator.
Stop it. I will blow you a kiss at my discretion. Begging is unbecoming.
You would totally nap twice a day if it were socially acceptable.
At least my pacifier doesn't give me a hangover.
Your failure to understand me doesn't constitute a lack in my ability to communicate.
My snuggles could solve major international problems.
According to my research. I'm acting my age. You, my friend, have no such excuse.

In the preferred embodiment, the memory 16 will contain up to 100 different sound clips stored in the strap that in a preferred embodiment will last 4-6 seconds each and in other embodiments may last up to 150 seconds. The device will recite a single saying with each button push. A mini-USB connection 24 will allow recharging of the battery after approximately 700 clicks. In another embodiment the battery is non-replaceable, non-rechargeable allowing for reduced manufacturing costs. All the electronics will be preferably housed between two strips of fabric 26, 28 on the strap and double stitched 30, 32 for safety. Alternatively, the strap can be made of plastic or other flexible material with the electronics attached to one surface of the strap or between straps that are heat sealed or glued. The strap 12 will have a traditional loop tie connection 34 to the pacifier 14 and a shirt clip 36 on the opposite side.

Niche variations would utilize identical electronics, pacifier and overall design. However, a new set of recordings tailored to the topic and appropriate imagery will visually distinguish the subject matter and create a never-ending platform of musings: holidays, sports teams, political, superheroes, hobbies, etc. For example, the following are copyrighted University of Florida niche musings:
The only thing that slobbers more than me is a Georgia Bulldog.
How many Serainoles did it take to tackle Tebow? Good question, nobody knows.
Nick Saban cheats. There is no other feasible explanation.
Take the pacifier. Maybe it can help quiet down that tomahawk chop.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

What is claimed is:

1. A novelty infant pacifier comprising: a pacifier;
a strap formed from an elongated piece of flexible material having a proximal end secured to said pacifier and a distal end having a mechanism for coupling to object to prevent misplacement of said pacifier; a chamber formed between said first and second end; a microprocessor coupled to a speaker positioned within said chamber; a power source electrical coupled to said microprocessor; and a switch positioned between said power source and said microprocessor for coupling said power source to said microprocessor; whereby said strap is attached to object such as an infant's shirt and activation of said switch allows power to said microprocessor to produce sounds through said speaker whereby said sounds entertain those surrounding said infant for the purpose of entertainment, soothing, or education.

2. The novelty infant pacifier according to claim 1 including a memory chip coupled to said microprocessor, said memory chip having prerecorded sounds.

3. The novelty infant pacifier according to claim 2 wherein said memory chip will store up to 100 sound clips.

4. The novelty infant pacifier according to claim 2 wherein said sounds are up to 150 seconds in duration.

5. The novelty infant pacifier according to claim 2 wherein said microprocessor selects sound musings stored on said memory chips by requested selection or by random selection.

6. The novelty infant pacifier according to claim 5 wherein said short musings are about life as a baby.

7. The novelty infant pacifier according to claim 1 wherein said switch is further defined as a push button, wherein said push button can be activated to provide power from said battery source to said microprocessor by pushing, pulling twisting or squeezing.

8. The novelty infant pacifier according to claim 1 wherein said switch is selected from the activation group consisting of: a motion sensor, Bluetooth, or a wi-fi coupling.
